(19) United States
(12) Patent Application Publication
(10) Pub. No.: US 2006/0232092 A1
(43) Pub. Date: Oct. 19, 2006

(54) Windscreen wiper device in particular for a motor vehicle

(76) Inventor: Armin Stubner, Buehl-Altschweier (DE)

Correspondence Address: MICHAEL BEST & FRIEDRICH, LLP, 100 E WISCONSIN AVENUE, MILWAUKEE, WI, 53202, US

(21) Appl. No.: 10/569,393

(22) PCT Filed: Jun. 2, 2004
(86) PCT No.: PCT/DE04/01123

§ 371 Date: Feb. 22, 2006

(30) Foreign Application Priority Data
Sep. 8, 2003 (DE) 10341282.4

(51) Int. Cl. B60S 1/06

(52) U.S. Cl. 296/96.17; 15/250.31; 15/250.3

(57) ABSTRACT

A windshield wiper device (10), in particular for a motor vehicle, is disclosed, comprising a fixing section (32) for fixing the windshield wiper device (10) in or on the motor vehicle, which features a decoupling element (30), whereby a connecting element (28) is provided on the decoupling element (30) so that the decoupling element (30) is fixed to the windshield wiper device (10) by means of a connection process.

### BACKGROUND OF THE INVENTION

The invention relates to a windshield wiper device, in particular for a motor vehicle.

Numerous windshield wiper devices for motor vehicles are already known, which feature a decoupling element that serves to fix the windshield wiper device in or on the motor vehicle. For example, a windshield wiper device is known from DE-A-101 14 033, in which an annular decoupling element is provided with a screw that is used for fixing to the body of the motor vehicle.

However, these types of decoupling elements are very large and must be threaded in during manufacturing in a relatively expensive manner. In addition, these elements are only conditionally suitable for a wiper direct drive, in which the wiper arm is connected to the wiper blade directly with the driven shaft of a drive device—without a thrust rod gear. In the case of these types of windshield wiper devices, the drive unit essentially includes only one electric motor with a step-down gear.

In addition, most of the time commercially available decoupling elements are provided with screwed connections, which cannot be realized in diecast parts without an additional work cycle, however.

### SUMMARY OF THE INVENTION

The windshield wiper device in accordance with the invention has the advantage that because of the arrangement of a connecting element on the decoupling element, a simple connection is available to fix the decoupling element on the windshield wiper device. This makes simple assembly of the windshield wiper device possible, whereby particularly in series manufacturing a considerable cost advantage is achieved.

If the connecting element has a snap interlock, then a secure connection of the decoupling element to the windshield wiper device is advantageously produced.

An especially good connection is advantageously produced by the connecting element engaging in an internal cylindrical formation on the windshield wiper device.

In a simple and cost-effective embodiment, the connecting element is embodied as a speed nut.

The damping section of the decoupling element is advantageously embodied of an elastic material in order to effectively dampen vibrations of the windshield wiper device and prevent transmission to the vehicle body.

In addition, it is also considered advantageous if the windshield wiper device has a drive unit with a gearbox housing and the decoupling element acts on the gearbox housing so that the damping via the damping section is arranged as close as possible to the source of emission, i.e., the drive unit.

Because of the three decoupling elements, the fastening is precisely determined statically and offers optimal hold on the body of the motor vehicle.

It is especially advantageous if the decoupling element features a fixing section, which is adhered to or vulcanized on the damping section.

In a simple design, the fixing section features an internal or external screw thread for a screwed connection to the motor vehicle.

In an advantageous design, the windshield wiper device is provided for a wiper direct drive in which a thrust rod gear is dispensed with and the wiper arm is connected to the wiper blade directly with the driven shaft of the drive unit.

### BRIEF DESCRIPTION OF THE DRAWINGS

One exemplary embodiment of the invention is depicted in the drawings and described in greater detail in the following description. The drawings show:

FIG. 1 A schematic cross-sectional depiction of a windshield wiper device in accordance with the invention.

FIG. 2 A cross-sectional depiction of a decoupling element of windshield wiper device in accordance with the invention.

FIG. 3 A variation of the decoupling element from FIG. 2.

### DETAILED DESCRIPTION

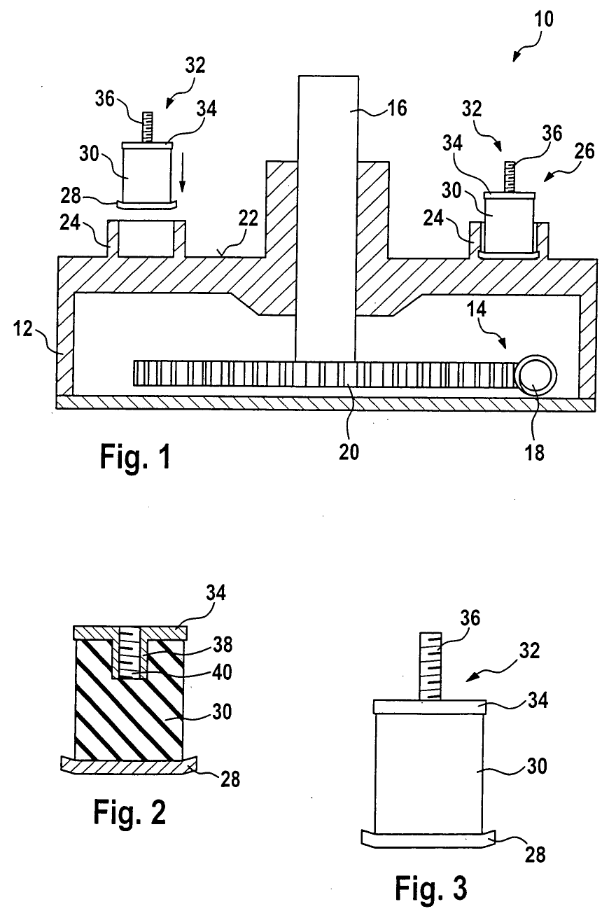

FIG. 1 shows a schematic cross-section depiction of a windshield wiper device 10 in accordance with the invention. The windshield wiper device 10 essentially comprises a drive unit, which is not depicted here for reasons of clarity, as well as gearbox housing 12 surrounding a gear 14 with a driven shaft 16, which projects out of the gearbox housing 12. The gear 14 includes at least one worm 18, which meshes with a worm wheel 20 that is connected in its rotational center to the driven shaft 16 so that it is resistant to torsion.

On the outside 22 of the gear housing 12 facing the driven shaft 16, said housing has three receptacles 24, which are embodied as hollow cylindrical elevations. A decoupling element 26 is placed in each of the receptacles 24. Naturally, only two receptacles 24, but also four or more receptacles 24 can be provided as an alternative.

The decoupling element 26 essentially has three sections. The first section is comprised of a connecting element 28, which is embodied as a speed nut, and therefore is composed of a circular disk, which is bent upward in a claw-like manner on its circumference, i.e., concave to the surface in the outer side 22 of the gearbox housing 12. The diameter of the speed nut in this case is somewhat greater than the diameter of the hollow cylindrical receptacle 24. In this way, a snap interlock is produced between the receptacle 24 and the connecting element 28. During assembly of the windshield wiper device 10, the connecting element 28 can therefore be fastened to the gearbox housing 12 of the windshield wiper device 10 by means of a simple connecting process. As a supplement to this, the speed nut 28 can also have a sharp edge along its circumference, which provides for optimal hold of the speed nut 28 in the receptacle 24.

Adjacent to the connecting element 28 is the damping section 30, which is composed of an elastic material, in particular rubber, and is embodied to be cylindrical. The damping section 30 has a diameter that is somewhat smaller than the diameter of the connecting element 28 and has a height that is at least as high as the diameter of the damping section 30. The connecting element 28 and the damping section 30 are adhered to one another, or the connecting element 28 is vulcanized to the damping section 30.

The fixing section 32 is adjacent to the damping section 30, diametric to the connecting element 28. This fixing section is essentially comprised of a plate 34 from whose plane a threaded rod 36 extends as an external screw thread. The threaded rod 36 is used for fastening to the body of the motor vehicle. The decoupling element 26 is already mounted at the vehicle manufacturer so that the windshield wiper device 10 is only inserted into the corresponding openings and must be locked. Alternatively, any other connection can naturally also be provided as a fixing section 32; rotational, snap and clip connections are mentioned here in particular.

FIG. 2 depicts a variation of the decoupling element 32 from FIG. 1. The fixing section 32 in this case is embodied as a plate from whose plane a cylindrical projection 38 extends, which is provided with an internal screw thread 40. The projection 38 extends in the direction of the damping section 30, which has a corresponding recess for it.

FIG. 3 shows the fixing element 32 from FIG. 1 in detail. As the connecting element 28, the speed nut is concavely curved and has a relatively sharp edge along its circumference. The purpose of this edge is so that the speed nut 28 can dig into the receptacle 24 when an effect of force attempts to pull the speed nut 28 out of the receptacle 24. Adjacent to the connecting element 28 is the damping section 30, which is composed of rubber under the absorption of vibrational energy that is provided. Adjacent in turn to this is the fixing section 32, which is adhered to or vulcanized on the damping section 30.

In a variation of the invention, the decoupling element 26 and the receptacle 24 are by no means circular, but can naturally also be elliptical or otherwise oval. Typically, the three receptacles 24 are circular and the driven shaft 16 is always arranged at an angle of 120 degrees. In this case, one of the receptacles 24 can also be offset somewhat so that during installation in the motor vehicle a defined angular position is always prescribed.

Typically, a wiper arm, which bears a wiper blade, is directly attached to the driven shaft 16. This is the case with so-called wiper direct drives, in which a conventional thrust rod gear is dispensed with.

1. Windshield wiper device (10), in particular for a motor vehicle, with a decoupling element (26) for fixing the windshield wiper device (10) in or on the motor vehicle, which features a damping section (30), characterized in that a connecting element (28) is provided on the decoupling element (26) so that the decoupling element (26) is fixed to the windshield wiper device (10) by means of a connection process.

2. Windshield wiper device (10) according to claim 1, characterized in that the connecting element (28) has a snap interlock.

3. Windshield wiper device (10) according to claim 1, characterized in that the connecting element (28) engages in an internal cylindrical formation on the windshield wiper device (10).

4. Windshield wiper device (10) according to claim 1, characterized in that the connecting element (28) is embodied as a speed nut.

5. Windshield wiper device (10) according to claim 1, characterized in that the damping section (30) is embodied of an elastic material.

6. Windshield wiper device (10) according to claim 1, characterized in that a drive unit is provided with a gearbox housing (12) and the decoupling element (26) acts on the gearbox housing (12).

7. Windshield wiper device (10) according to claim 1, characterized in that precisely three decoupling elements (26) are provided.

8. Windshield wiper device (10) according to claim 1, characterized in that the decoupling element (26) features a fixing section (32), which is adhered to or vulcanized on the damping section (30).

9. Windshield wiper device (10) according to claim 8, characterized in that the fixing section (32) features an internal or external screw thread (36, 40) for a screwed connection to the motor vehicle.

10. Windshield wiper device (10) according to claim 1, characterized in that the windshield wiper device (10) is provided for a wiper direct drive.

11. Windshield wiper device (10) according to claim 2, characterized in that the connecting element (28) engages in an internal cylindrical formation on the windshield wiper device (10).

12. Windshield wiper device (10) according to claim 11, characterized in that the connecting element (28) is embodied as a speed nut.

13. Windshield wiper device (10) according to claim 12, characterized in that the damping section (30) is embodied of an elastic material.

14. Windshield wiper device (10) according to claim 13, characterized in that a drive unit is provided with a gearbox housing (12) and the decoupling element (26) acts on the gearbox housing (12).

15. Windshield wiper device (10) according to claim 14, characterized in that precisely three decoupling elements (26) are provided.

16. Windshield wiper device (10) according to claim 15, characterized in that the decoupling element (26) features a fixing section (32), which is adhered to or vulcanized on the damping section (30).

17. Windshield wiper device (10) according to claim 16, characterized in that the fixing section (32) features an internal or external screw thread (36, 40) for a screwed connection to the motor vehicle.

18. Windshield wiper device (10) according to claim 17, characterized in that the windshield wiper device (10) is provided for a wiper direct drive.
